(19) United States
(12) Patent Application Publication
(10) Pub. No.: US 2006/0166641 A1
(43) Pub. Date: Jul. 27, 2006

(54) Vooms-virtual office or mobile system

(76) Inventor: Leonard Edwin, Oakville (CA)

Correspondence Address: Raymond M. Galasso;Galasso & Associates LP, P.O. Box 26503, Austin, TX, 78755-0503, US

(21) Appl. No.: 11/338,234

(22) Filed: Jan. 24, 2006

Related U.S. Application Data
(60) Provisional application No. 60/646,306, filed on Jan. 24, 2005.

(51) Int. Cl. H04B 1/08

(52) U.S. Cl. 455/349

(57) ABSTRACT

VOOMS-Virtual Office or Mobile System consists of a personal communications gateway device, a pocket-personal computer, and a simulated, wide-view presentation device to communicate with the personal communications gateway device and pocket-personal computer. It works by utilizing several known technologies already in use for accessing the internet and home and office networks while also allowing the user to conveniently view the accessed information through the use of the wide-view presentation device.

### CROSS REFERENCE TO RELATED APPLICATIONS

This Non-Provisional Patent Application claims priority to United States Provisional Patent Application No. 60/646,306 entitled “VOOMS-Virtual Office or Mobile System” filed Jan. 24, 2005.

### FIELD OF THE DISCLOSURE

The disclosures made herein relate generally to communications equipment. The invention discussed herein is in the general classification of mobile communications devices.

### BACKGROUND

Constant communication among groups is vital in a technologically advanced business climate. The markets for word processors, televisions, cellular telephones and computers have consistently expanded in recent years and the technology used in conjunction with these devices continues to improve. It is commonplace for individuals to use laptop computers or personal data assistants to record data or link to a worldwide information processing system in public forums. However, it is difficult for some users to access all of the information they desire in a convenient, hand-held unit. Laptop devices can be unwieldy and personal data assistants do not provide a convenient, large display of information.

Hence, there is a need in the art for a unified system that will allow individuals access to an integrated, portable communication system, permitting a user to acquire and transmit information through the use of a reliable, economical electronic network.

### SUMMARY OF THE DISCLOSURE

VOOMS-Virtual Office or Mobile System consists of a personal communications gateway (PCG) device, a pocket-personal computer (PPC), and a simulated, wide-view presentation device to communicate with the PCG device and PPC. It utilizes several known technologies already in use for accessing the internet and home and office networks.

The principal object of this invention is to provide a solution to the challenge for affordable wireless broadband internet services by mobile users, via a light-weight “wearable” alternative to the aging laptop.

Another object of this invention is to provide mobile access to office and personal/home based network environments of voice, data, video and applications through a secure wireless communication.

Yet another object of this invention is to provide a convenient to use mobile communications system.

### BRIEF DESCRIPTION OF THE DRAWINGS

FIG. 1 depicts a perspective view of the preferred embodiment of the pocket-personal computer of the present invention.

FIG. 2 depicts a perspective view of the preferred embodiment of the personal communications gateway device of the present invention.

FIG. 3 depicts a perspective view of the preferred embodiment of the simulated wide-view presentation device of the present invention.

### DETAILED DESCRIPTION OF THE DRAWINGS

VOOMS-Virtual Office or Mobile System is comprised of at least some of the following: a personal communications gateway device, a pocket-personal computer, and a simulated, and a wide-view presentation device to communicate with the personal communications gateway device and pocket-personal computer.

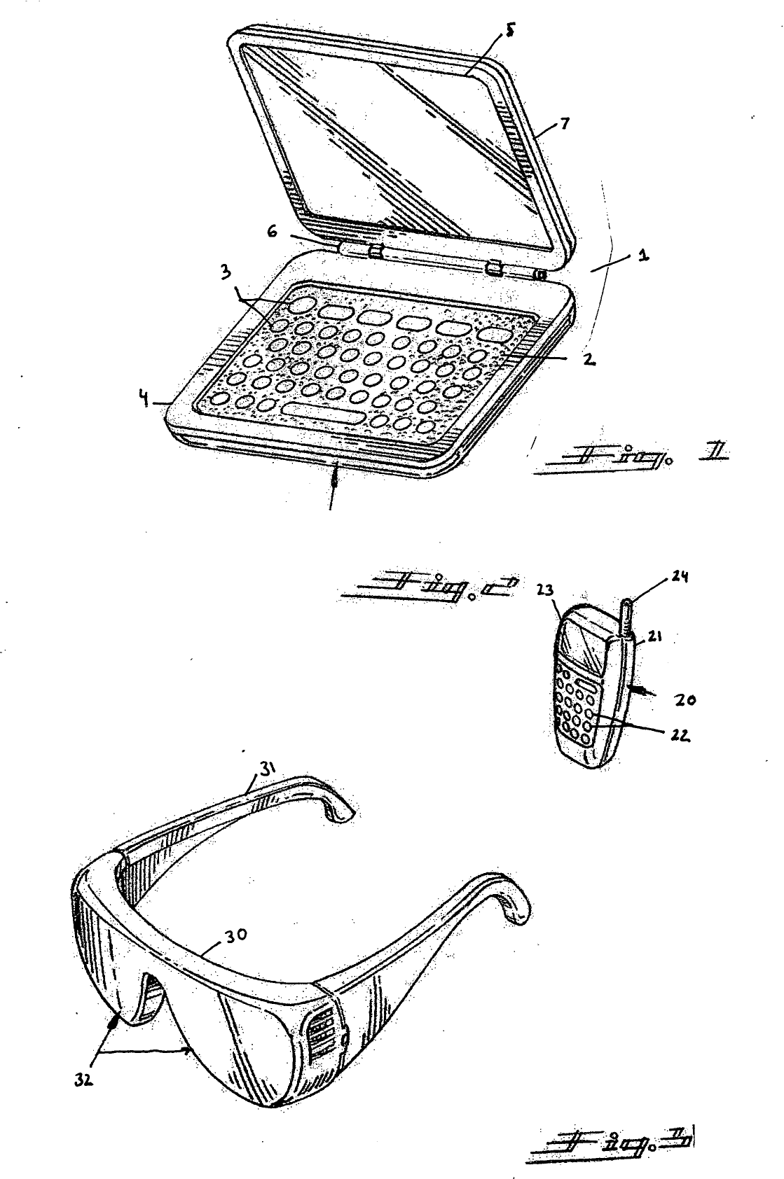

FIG. 1 depicts the preferred embodiment of the pocket-personal computer 1. The pocket-personal computer 1 is a portable, miniature version of a personal computer. It has a keyboard 2 with a plurality of keys 3 on a plastic base 4. The base 4 encases a circuit board (not shown) and internal memory (not shown). The base 4 is connected to a monitor 5 via a hinging mechanism 6 that permits the base 4 and monitor 5 to be folded for convenient transport. The monitor 5 is surrounded by a plastic frame 7 to protect the monitor 5 from damage during transport and use.

Obviously, the pocket-personal computer 1 will utilize many known features and technologies such as a battery-compartment and wireless capability to communicate with the personal communications gateway device or a port that permits attachment to the personal communications gateway device.

While the size of the pocket-personal computer 1 can vary, it will ideally be eight inches long, six inches wide and one inch thick when the monitor 5 and base 4 are folded together for transport.

FIG. 2 depicts the preferred embodiment of the personal communications gateway device 20. The personal communications gateway device 20 is shaped roughly like a cellular telephone. The personal communications gateway device 20 has a plastic frame 21 with a plurality of keys 22, a display screen 23 and an antenna 24. Again, the plastic frame 21 encases a circuit board (not shown) and internal memory (not shown). The personal communications gateway device 20 also has wireless internet capabilities and a port for attachment to the pocket-personal computer.

FIG. 3 depicts the preferred embodiment of the simulated wide-view presentation device 30. The simulated wide-view presentation device 30 is shaped like a set of goggles to permit easy use. The simulated wide-view presentation device 30 has two ear-pieces 31 and lenses 32.

The pocket-personal computer, personal communications device and wide-view presentation devices described in FIGS. 1-3, work in conjunction with one another to permit a user to access internet and personal and home networks. The personal communications gateway device has wireless and phone service connectivity and user authentication capabilities (VPN) to allow access to network data and multimedia services in a secure environment. The pocket-personal computer attaches to the personal communications gateway device to allow data-entry, interaction and navigation of all accessed services. The wide-view presentation device connects to the personal communications gateway device and the miniature personal computer and permits easy viewing of the information from the accessed services.

The components of VOOMS-Virtual Office or Mobile System may vary widely but will likely utilize metal, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of VOOMS-Virtual Office or Mobile System can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A communications system comprising:
(a) a personal communications gateway device with wireless connectivity capabilities;
(b) a miniature personal computer that attaches to the personal communications gateway device; and
(c) a wide-view presentation device that connects to the personal communications gateway device and the miniature personal computer.

2. The communications system of claim 1 wherein the personal communications gateway device has user authentication capabilities.

3. The communications system of claim 1 wherein the personal communications gateway device has phone service connectivity.

4. The communications system of claim 1 wherein the miniature personal computer has a monitor and a keyboard connected by a hinging mechanism to allow the monitor and the keyboard to fold together.

5. The communications system of claim 1 wherein the miniature personal computer has a voice recognition system.

6. The communications system of claim 1 wherein the wide-view presentation device is shaped like goggles.
